(19) United States
(12) Patent Application Publication
(10) Pub. No.: US 2006/0184840 A1
(43) Pub. Date: Aug. 17, 2006

(54) Using timebase register for system checkstop in clock running environment in a distributed nodal environment

(75) Inventors: Michael Stephen Floyd, Austin, TX (US); Larry Scott Leitner, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/055,827

(22) Filed: Feb. 11, 2005

(51) Int. Cl. G06F 11/00

(52) U.S. Cl. 714/48

(57) ABSTRACT

A mechanism is provided for determining a cause of a primary error in a complex communications topology without clockstop. A time of day register, or another synchronized register, is provided in each node of the topology for another existing purpose. When an error is encountered, a copy of the register is captured and frozen. The node with the lowest value in the register is determined to be the node that saw the error first. With the copy of the register frozen, the system can continue to function using the time of day register. For the case of determining the cause of primary error for system checkstop only, the actual register may be frozen, providing a solution without requiring the addition of latches to the design.

### BACKGROUND OF THE INVENTION

1. Technical Field

The present invention generally relates to computer systems and, more specifically, to an improved method of determining the source of a system error which might have arisen from any one of a number of components that are interconnected in a complex communications topology.

2. Description of Related Art

As multi-processor computer systems increase in size and complexity, there has been an increased emphasis on diagnosis and correction of errors that arise from the various system components. While some errors can be corrected by error correction code (ECC) logic embedded in these components, there is still a need to determine the cause of these errors since the correction codes are limited in the number of errors they can both correct and detect. Generally, ECC codes used are single error correct/double error detect (SEC/DED) type codes. Hence, when a persistent correctable error occurs, it is desirable to call for replacement of the defective component as soon as possible to avoid a second error from creating an uncorrectable error and causing the system to crash.

When the system has fault or defect that causes a system error, it can be difficult to determine the original source of the primary error since the corruption can cause secondary errors to occur downstream on other chips or devices within the system. This corruption can take the form of either recoverable or checkstop (system fault) conditions. Many errors are allowed to propagate due to performance issues. In-line error correction can introduce a significant delay into the system, so ECC might be used only at the final destination of a data packet (the data “consumer”) rather than at its source or at an intermediate node. Accordingly, for a recoverable error, there often is insufficient time to ECC correct before forwarding the data without adding undesirable latency to the system. Therefore, bad data may intentionally be propagated to subsequent nodes or chips.

For both recoverable and checkstop errors, it is important for diagnostics firmware to be able to analyze the system and determine with certainty the primary source of the error, so appropriate action can be taken. Corrective actions may include preventative repair of a component, deconfiguration of selected resources, and/or a service call for replacement of the defective component if it is a field replaceable unit (FRU) that can be replaced with a fully operational unit.

### SUMMARY OF THE INVENTION

The present invention recognizes the disadvantages of the prior art and provides a mechanism for determining a cause of a primary error in a complex communications topology without clockstop. The present invention uses a time of day register in each node of the topology. When an error is encountered, a copy of the time of day register is captured and frozen. The node with the lowest time of day value is determined to be the node that saw the error first. With the copy of the time of day register frozen, the system can continue to function using the time of day register. For the case of determining the cause of primary error for system checkstop only, the actual time of day register may be frozen without adding additional latches to the design.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of an illustrative embodiment of a data processing system with which the present invention may advantageously be utilized;

FIG. 2 illustrates a simple communications topology in which a “who's on first” counter may be used to determine the source of an error;

FIG. 3 illustrates a complex communications topology in which exemplary aspects of the present invention may be utilized;

FIGS. 4A-4D illustrate an example distributed nodal environment with time of day register used for system checkstop in accordance with exemplary embodiments of the present invention; and

FIG. 5 is a flowchart illustrating the operation of a data processing system using a time of day register for system checkstop in accordance with an exemplary embodiment of the present invention.

### DETAILED DESCRIPTION OF THE PREFERRED EMBODIMENT

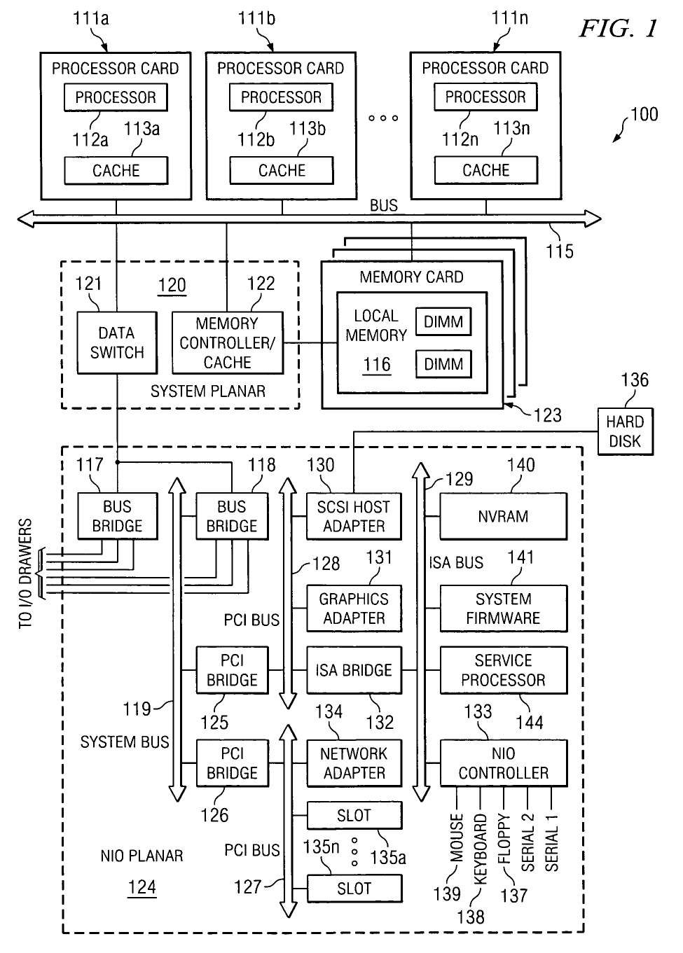

The present invention provides a method and apparatus for using time of day register for system checkstop in clock running environment in a distributed nodal environment. The exemplary aspects of the present invention may be embodied within a data processing system that may be a stand-alone computing device or may be a distributed data processing system in which multiple computing devices are utilized to perform various aspects of the present invention. Therefore, the following FIG. 1 is provided as an exemplary diagram of a data processing environment in which the present invention may be implemented. It should be appreciated that FIG. 1 is only exemplary and is not intended to assert or imply any limitation with regard to the environments in which the present invention may be implemented. Many modifications to the depicted environment may be made without departing from the spirit and scope of the present invention.

Referring now to the drawings and in particular to FIG. 1, there is depicted a block diagram of an illustrative embodiment of a data processing system with which the present invention may advantageously be utilized. As shown, data processing system 100 includes processor cards 111a-111n. Each of processor cards 111a-111n includes a processor and a cache memory. For example, processor card 111a contains processor 112a and cache memory 113a, processor card 111b contains processor 112b and cache memory 113b, and processor card 111n contains processor 112n and cache memory 113n.

Processor cards 111a-111n are connected to main bus 115. Main bus 115 supports a system planar 120 that contains processor cards 111a-111n and memory cards 123. The system planar also contains data switch 121 and memory controller/cache 122. Memory controller/cache 122 supports memory cards 123 that includes local memory 116 having multiple dual in-line memory modules (DIMMs).

Data switch 121 connects to bus bridge 117 and bus bridge 118 located within a native I/O (NIO) planar 124. As shown, bus bridge 118 connects to peripheral components interconnect (PCI) bridges 125 and 126 via system bus 119. PCI bridge 125 connects to a variety of I/O devices via PCI bus 128. As shown, hard disk 136 may be connected to PCI bus 128 via small computer system interface (SCSI) host adapter 130. A graphics adapter 131 may be directly or indirectly connected to PCI bus 128. PCI bridge 126 provides connections for external data streams through network adapter 134 and adapter card slots 135a-135n via PCI bus 127.

An industry standard architecture (ISA) bus 129 connects to PCI bus 128 via ISA bridge 132. ISA bridge 132 provides interconnection capabilities through NIO controller 133 having serial connections Serial 1 and Serial 2. A floppy drive connection 137, keyboard connection 138, and mouse connection 139 are provided by NIO controller 133 to allow data processing system 100 to accept data input from a user via a corresponding input device. In addition, non-volatile RAM (NVRAM) 140 provides a non-volatile memory for preserving certain types of data from system disruptions or system failures, such as power supply problems. A system firmware 141 is also connected to ISA bus 129 for implementing the initial Basic Input/Output System (BIOS) functions. A service processor 144 connects to ISA bus 129 to provide functionality for system diagnostics or system servicing.

The operating system (OS) is stored on hard disk 136, which may also provide storage for additional application software for execution by data processing system. NVRAM 140 is used to store system variables and error information for field replaceable unit (FRU) isolation. During system startup, the bootstrap program loads the operating system and initiates execution of the operating system. To load the operating system, the bootstrap program first locates an operating system kernel type from hard disk 136, loads the OS into memory, and jumps to an initial address provided by the operating system kernel. Typically, the operating system is loaded into random-access memory (RAM) within the data processing system. Once loaded and initialized, the operating system controls the execution of programs and may provide services such as resource allocation, scheduling, input/output control, and data management.

The present invention may be executed in a variety of data processing systems utilizing a number of different hardware configurations and software such as bootstrap programs and operating systems. The data processing system 100 may be, for example, a stand-alone system or part of a network such as a local-area network (LAN) or a wide-area network (WAN).

When the system has a fault or defect that causes a system error, it can be difficult to determine the original source of the primary error since the corruption can cause secondary errors to occur downstream on other chips or devices connected to the SMP fabric. This corruption can take the form of either recoverable or checkstop (system fault) conditions. Many errors are allowed to propagate due to performance issues. In-line error correction can introduce a significant delay into the system, so ECC might be used only at the final destination of a data packet (the data “consumer”) rather than at its source or at an intermediate node.

Accordingly, for a recoverable error, there often is insufficient time to ECC correct before forwarding the data without adding undesirable latency to the system. Therefore, bad data may intentionally be propagated to subsequent nodes or chips. For both recoverable and checkstop errors, it is important for diagnostics firmware to be able to analyze the system and determine with certainty the primary source of the error, so appropriate action can be taken. Corrective actions may include preventative repair of a component, deconfiguration of selected resources, and/or a service call for replacement of the defective component if it is an FRU that can be replaced with a fully operational unit.

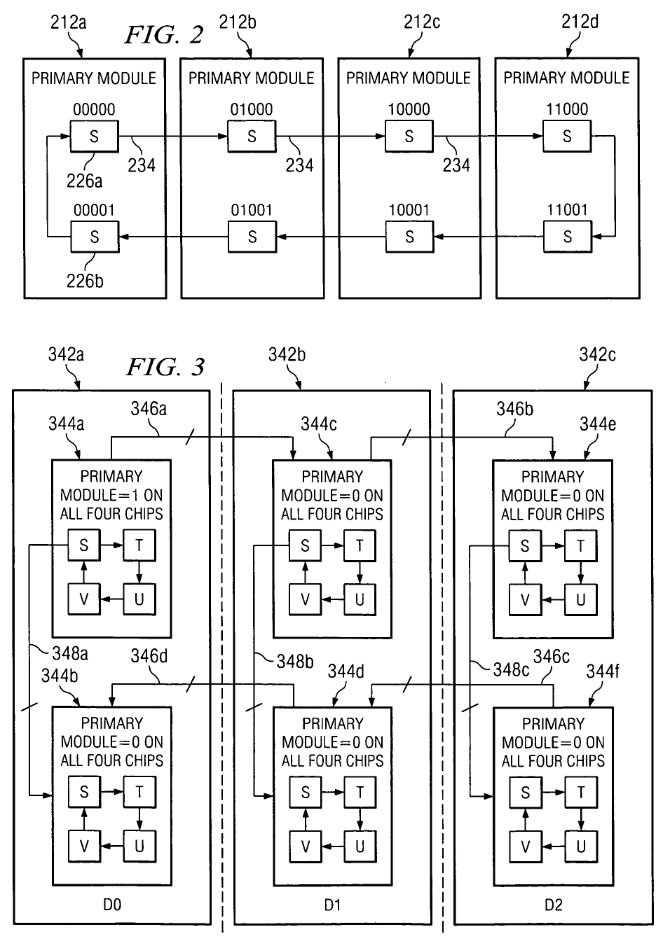

For system 100, the method used to isolate the original cause of the error may utilize a plurality of counters or timers, one located in each component, and communication links that form a loop through the components. For example, a simple communications topology for the processors of system 100 may be as shown in FIG. 2. A plurality of data pathways or buses 234 allows communications between adjacent processor cores in the topology. Each processor core is assigned a unique processor identification number. In one embodiment, one processor core is designated as the primary module, in this case core 226a. This primary module has a communications bus 234 that feeds information to one of the processor cores in processing unit 112b.

Communications bus 234 may comprise data bits, controls bits, and an error bit. In the example depicted in FIG. 2, each counter in a given processor core starts incrementing when an error is first detected and, after the system error indication has traversed the entire bus topology (via the error bit in bus 234) and returned to that given core, the counters stop. The counters can then be examined to identify the component with the largest count, indicating the primary source of the error.

While this approach to fault isolation is feasible with a simple ring (single-loop) topology, it is not viable for more complicated processing unit constructions which might have, for example, multiple loops criss-crossing in the communications topology. In such constructions, there is no guarantee that the counter with the largest count corresponds to the defective component, since the error may propagate through the topology in an unpredictable fashion determined by exactly which chip experiences the primary error and how the particular data or command packet is being routed along the fabric topology.

Although a fault isolation system might be devised having a central control point which could monitor the components to make the determination, the trend in modern computing is moving away from such centralized control since it presents a single failure point that can cause a system-wide shutdown. It would, therefore, be desirable to devise an improved method of isolating faults in a computer system having a complicated communications topology, to pinpoint the source of a system error from among numerous components. It would be further advantageous if the method could utilize existing pathways between the components rather than further complicate the chip wiring with additional interconnections.

With reference now to FIG. 3, there is depicted an implementation of a processor group 340 for a symmetric multi-processor (SMP) computer system. In this particular implementation, processor group 340 is composed of three drawers 342a, 342b and 342c of processing units. Although only three drawers are shown, the processor group could have fewer or additional drawers. The drawers are mechanically designed to slide into an associated frame for physical installation in the SMP system. Each of the processing unit drawers includes two multi-chip modules (MCMs), i.e., drawer 342a has MCMs 344a and 344b, drawer 342b has MCMs 344c and 344d, and drawer 342c has MCMs 344e and 344f. Again, the construction could include more than two MCMs per drawers. Each MCM in turn has four integrated chips, or individual processing units (more or less than four could be provided). The four processing units for a given MCM are labeled with the letters “S,” “T,” “U,” and “V.” There are accordingly a total of twenty-four processing units or chips shown in FIG. 3.

Each processing unit is assigned a unique identification number (PID) to enable targeting of transmitted data and commands. One of the MCMs is designated as the primary module, in this case MCM 344a, and the primary chip S of that module is controlled directly by a service processor. Each MCM may be manufactured as a field replaceable unit (FRU) so that, if a particular chip becomes defective, it can be swapped out for a new, functional unit without necessitating replacement of other parts in the module or drawer. Alternatively, the FRU may be the entire drawer (the preferred embodiment) depending on how the technician is trained, how easy the FRU is to replace in the customer environment and the construction of the drawer.

Processor group 340 is adapted for use in an SMP system, which may include other components such as additional memory hierarchy, a communications fabric and peripherals, as discussed in conjunction with FIG. 1. The operating system for the SMP computer system is preferably one that allows certain components to be taken off-line while the remainder of the system is running, so that replacement of an FRU can be effectuated without taking the overall system down.

Various data pathways are provided between certain of the chips for performance reasons, in addition to the interconnections available through the communications fabric. As seen in FIG. 3, these paths include several inter-drawer buses 346a, 346b, 346c, and 346d, as well as intra-drawer buses 348a, 348b, and 348c. There are also intra-module buses, which connect a given processing chip to every other processing chip on that same module. In the exemplary embodiment, each of these pathways provides 128 bits of data, 40 control bits, and one error bit.

Additionally there may be buses connecting a T chip with other T chips, a U chip with other U chips, and a V chip with V chips, similar to the S chip connections 346 and 348 as shown. Those buses are omitted for pictorial clarity. In this particular example, where the bus interfaces exist between all these chips include an error signal, the error signal is only actually used on those shown to achieve maximum connectivity and error propagation speed while limiting topological complexity.

Each processing chip (or more generally, any FRU in a SMP system) may have a counter/timer in the fault isolation circuitry. The counter may be referred to as a “who's on first” (WOF) counter. These counters may be used to determine which component was the primary source of an error that may have propagated to other “downstream” components of the system and generated secondary errors. As explained above, prior art fault isolation techniques use a counter that starts when an error is detected, and then stopped after the error traverses the ring topology. The counter with the biggest count then corresponds to the source of the error.

Alternatively, counters may be started at boot time (or some other common initialization time prior to an error event), and then a given counter may be stopped immediately upon detecting an error state. The counter with the lowest count would then identify the component that is the original source of the error. This technique is described in more detail in co-pending U.S. patent application Publication No. US 2004/0216003, entitled “MECHANISM FOR FRU FAULT ISOLATION IN DISTRIBUTED NODAL ENVIROJNMENT,” filed Apr. 28, 2003, published on Oct. 28, 2004, and herein incorporated by reference. However, in the above example, the counters require a significant amount of hardware dedicated to only this purpose and require a sophisticated synchronization method for the counters distributed across multiple chips.

Time of day (TOD) registers or clocks are registers that are initialized and synchronized between chips. Synchronization of TOD clocks among processing units is a well-studied problem. One example of TOD synchronization, among many such examples, is shown in U.S. Pat. No. 3,932,847, entitled “TIME-OF-DAY CLOCK SYNCHRONIZATION AMONG MULTIPLE PROCESSING UNITS,” filed Nov, 6, 1973, issued Jan. 13, 1976, and herein incorporated by reference.

In accordance with a preferred embodiment of the present invention, and existing TOD register on each chip is used as a global WOF counter. In one exemplary embodiment, when an error is encountered, the system clockstops immediately on system checkstop, and the TOD register is used to determine which chip clockstopped first. However, in more complex server systems, clockstop on error is not possible or desirable.

For the case where the system does not clockstop on checkstop, which is a default operation of the system in the field, it is desirable to have a simple way to tell which processor or computer chip in the system complex first saw the error condition that caused the machine to crash or that caused the data to be corrupted in the case of a recoverable error. In an exemplary embodiment of the present invention, an already existing counter that is available and synchronized as part of normal system boot is used to determine the first node to see the error. Please note that the counter used must increment at a rate equal to or greater than the time it takes for an error to propagate between processor chips. In one preferred embodiment of the present invention, the existing counter is the TOD register.

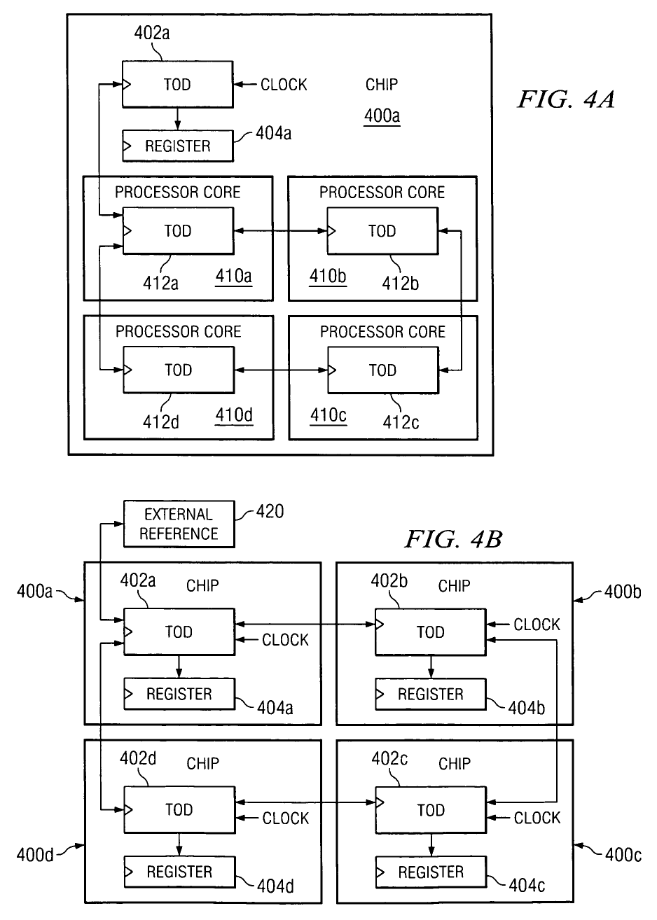

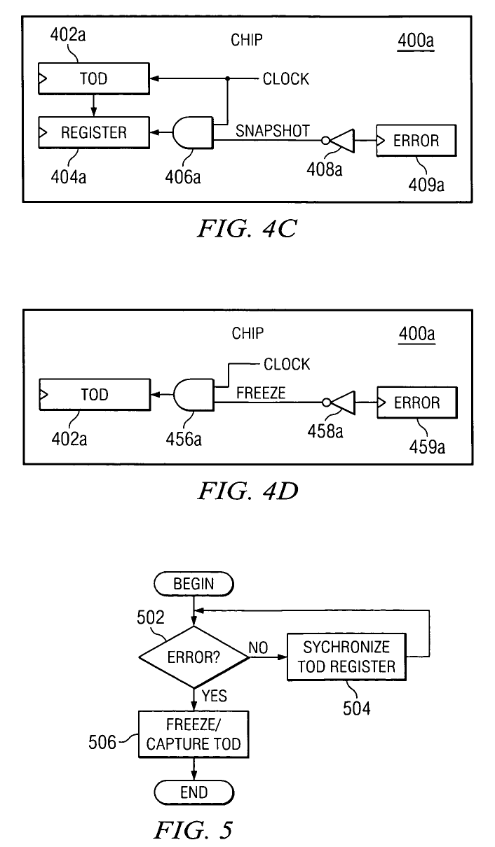

FIGS. 4A-4D illustrate an example distributed nodal environment with time of day register used for system checkstop in accordance with exemplary embodiments of the present invention. More particularly, with reference to FIG. 4A, chip 400a includes processor core 410a, processor core 410b, processor core 410c, and processor core 410d. Processor core 410a includes time of day (TOD) register 412a. Similarly, processor 410b includes TOD register 412b, processor 410c includes TOD 412c, and processor 410d includes TOD 412d.

Each TOD 412a-412d is initialized and counts forward to indicate a time of day or real time base value. Each TOD 412a-412d synchronizes with the other TOD registers on the chip. Thus, TOD 412a synchronizes with TOD 412b, TOD 412b synchronizes with TOD 412b, and so forth. One or more of TOD registers 412a-412d synchronizes with the TOD register 402a of chip 400a.

With reference now to FIG. 4B, chips 400a-400d may be, for example, chips on a drawer, as in the example in FIG. 3, or chips in a data processing system, such as processor cards 111a-111n in FIG. 1. Chip 400a includes time of day (TOD) register 402a. Similarly, chip 400b includes TOD register 402b, chip 400c includes TOD 402c, and chip 400d includes TOD 402d.

Each chip TOD 402a-402d is initialized and counts forward to indicate a time of day or real time base value. Each chip TOD 402a-402d synchronizes with the TOD registers on the other chips. Thus, TOD 402a synchronizes with TOD 402b, TOD 402b synchronizes with TOD 402b, and so forth. One or more of TOD registers 402a-402d synchronizes with an external time reference 410.

When an error is encountered, the value in the TOD register of each node is used to determine which node saw the error first. A node may be, for example a processor core, a chip, or the like. A system may clockstop immediately on system checkstop and the TOD counter in each chip may become frozen. Thus, in this circumstance, the TOD itself may be used to determine which clock stopped first. However, in more complex server systems, clockstop on error may not be possible or desirable.

In the example shown in FIG. 4A, register 404a is provided to capture the value of TOD register 402a when an error is encountered. Therefore, the clock may continue to run chip may continue to operate, using the TOD register, even after an error is encountered. Turning to FIG. 4B, after an error is encountered, one may examine registers 404a-404d to determine which chip encountered the error first.

FIG. 4C illustrates an example logic circuit for capturing a snapshot of the TOD register. A clock signal is provided to TOD register 402a. The value of TOD register 402a is provided to register 404a. The clock is provided to an input of AND gate 406a. Error latch 409a is activated by an error signal. Assuming a convention of latch 409a storing a logical “one” when an error is encountered, the value of latch 409a is inverted by inverter 408a and provided to the other input of AND gate 406a. Other conventions may be used and the logic shown in FIG. 4C may be modified accordingly. For example, latch 409a may instead store a logical “zero” when an error is encountered. FIG. 4C is meant to be illustrative of an example and not to imply structural limitations to the present invention.

Register 404a is “frozen” when an error is encountered. That is, when latch 409a has stored therein a logical “one,” the output of AND gate 406a will hold the clock input of register 404a to a logical “zero” value. Register 404a then stores a copy of TOD 402a, which identifies the time chip 400a encountered an error.

FIG. 4D illustrates an example logic circuit for freezing the TOD register in the case where the system clockstops on checkstop. A clock signal is provided to an input of AND gate 456a. Error latch 459a is activated by an error signal. Assuming a convention of latch 459a storing a logical “one” when an error is encountered, the value of latch 459a is inverted by inverter 458a and provided to the other input of AND gate 456a. Other conventions may be used and the logic shown in FIG. 4D may be modified accordingly. For example, latch 459a may instead store a logical “zero” when an error is encountered. FIG. 4D is meant to be illustrative of an example and not to imply structural limitations to the present invention.

TOD register 402a is “frozen” when an error is encountered. That is, when latch 459a has stored therein a logical “one,” the output of AND gate 456a will hold the clock input of TOD register 402a to a logical “zero” value. TOD 402a then identifies the time chip 400a encountered an error.

FIGS. 4C and 4D show the use of clock gating rather than data gating. In an alternative embodiment for FIG. 4C, the circuit may actually include a multiplexor in the data path from 402 to 404 for selecting between the TOD and itself (freeze). In FIG. 4D, the circuit may actually gate off the “increment” signal, not the clock. However, the examples shown in FIGS. 4C and 4D are illustrated simplicity but convey the same concept.

FIG. 5 is a flowchart illustrating the operation of a data processing system using a time of day register for system checkstop in accordance with an exemplary embodiment of the present invention. Operation begins and a determination is made as to whether an error is encountered (block 502). If an error is not encountered, the node synchronizes the time of day register (block 504) and returns to block 502 to determine if an error is encountered.

If an error is encounterd in block 502, the node freezes or captures the time of day register (block 506) and operation ends. The node freezes the time of day register if the system is configured to clockstop on checkstop. In this case, the clock simply stops and, thus, the TOD register stops counting. The TOD register may then be used to determine the time at which the node encountered the error. The node captures the TOD into another register when the system is not configured to clockstop on checkstop. The capture or “snapshot” register then stores the value of the TOD at the time the error was encountered. One may then examine the captured values of the TOD registers in a distributed nodal environment to determine which node encountered the error first.

Thus, the present invention solves the disadvantages of the prior art by providing a mechanism for determining a cause of a primary error in a complex communications topology without clockstop. The present invention uses a time of day register in each node of the topology. When an error is encountered, a copy of the time of day register is captured and frozen. The node with the lowest time of day value is determined to be the node that saw the error first. With the copy of the time of day register frozen, the system can continue to function using the time of day register. For the case of system checkstop, the actual time of day register may be frozen without adding additional latches.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for identifying a primary source of an error that propagates through a portion of a data processing system and generates secondary errors, the method comprising:
initializing a plurality of synchronized counters within a plurality of nodes within the data processing system, wherein the plurality of synchronized counters are pre-existing in the data processing system for a purpose other than error detection;
synchronizing the plurality of synchronized counters; and
responsive to an error in a given node within the plurality of nodes, capturing the synchronized counter in the given node in a snapshot register.

2. The method of claim 1, further comprising:
responsive to the error being discovered, identifying a node within the plurality of nodes with a lowest snapshot register value.

3. The method of claim 2, further comprising:
identifying the node with the lowest snapshot register value as the node within the plurality of nodes that saw the error first.

4. The method of claim 1, wherein the plurality of nodes are a plurality of processor chips in a data processing system.

5. The method of claim 4, wherein a given processor chip within the plurality of processor chips includes a plurality of processor cores.

6. The method of claim 5, wherein each processor core within the plurality of processor cores includes a synchronized counter, the method further comprising:
synchronizing the plurality of synchronized counters in the plurality of processor cores.

7. The method of claim 6, further comprising:
synchronizing at least one of the plurality of synchronized counters in the plurality of processor cores with the synchronized counter in the given processor chip.

8. The method of claim 1, further comprising:
synchronizing at least one of the plurality of synchronized counters with an external reference.

9. The method of claim 1, wherein the plurality of synchronized counters are a plurality of time of day clock registers.

10. An apparatus for identifying a primary source of an error that propagates through a portion of a data processing system and generates secondary errors, the apparatus comprising:
means for initializing a plurality of synchronized counters within a plurality of nodes within the data processing system, wherein the plurality of synchronized counters are pre-existing in the data processing system for a purpose other than error detection;
means for synchronizing the plurality of synchronized counters; and
means, responsive to an error in a given node within the plurality of nodes, for capturing the synchronized counter in the given node in a snapshot register.

11. The apparatus of claim 10, further comprising:
means, responsive to the error being discovered, identifying a node within the plurality of nodes with a lowest snapshot register value.

12. The apparatus of claim 11, further comprising:
means for identifying the node with the lowest snapshot register value as the node within the plurality of nodes that saw the error first.

13. The apparatus of claim 10, wherein the plurality of nodes are a plurality of processor chips in a data processing system.

14. The apparatus of claim 13, wherein a given processor chip within the plurality of processor chips includes a plurality of processor cores.

15. The apparatus of claim 14, wherein each processor core within the plurality of processor cores includes a synchronized counter, the apparatus further comprising:
means for synchronizing the plurality of synchronized counters in the plurality of processor cores.

16. The apparatus of claim 15, further comprising:
means for synchronizing at least one of the plurality of synchronized counters in the plurality of processor cores with the synchronized counter in the given processor chip.

17. The apparatus of claim 10, further comprising:
means for synchronizing at least one of the plurality of synchronized counters with an external reference.

18. The apparatus of claim 10, wherein the plurality of synchronization counters are a plurality of time of day clock registers.

19. An apparatus for identifying a primary source of an error that propagates through a portion of a data processing system and generates secondary errors, the apparatus comprising:
a plurality of chips, wherein each chip within the plurality of chips includes:
a time of day clock register;
a snapshot register; and
a logic circuit for capturing a snapshot of the time of day clock register into the snapshot register responsive to an error being encountered within the chip.

20. The apparatus of claim 19, wherein the time of day clock register is synchronized with at least one other time of day register.
